(19) United States
(12) Patent Application Publication
(10) Pub. No.: US 2002/0042775 A1
(43) Pub. Date: Apr. 11, 2002

(54) Method and apparatus for contribution-based gift purchasing

(76) Inventors: Lara M. Nelson, Sunnyvale, CA (US); C. Douglass Thomas, Campbell, CA (US); Peggy A. Su, Sunnyvale, CA (US)

Correspondence Address: Lara M. Nelson, 466 Costa Mesa Terrace, Unit D, Sunnyvale, CA, 94085, US

(21) Appl. No.: 09/974,944

(22) Filed: Oct. 10, 2001

Related U.S. Application Data
(60) Provisional application No. 60/239,418, filed on Oct. 10, 2000.

(51) Int. Cl. G06F 17/60

(52) U.S. Cl. 705/39; 705/5; 705/6

(57) ABSTRACT

Methods and apparatus for purchasing increments of a commodity are disclosed. According to one aspect of the present invention, a computer-implemented method for processing a request to purchase a portion of a commodity that is divided into multiple payment divisions includes receiving a request to purchase at least one of the payment divisions. After receiving a request to purchase the one or more payment divisions, payment information associated with the purchase of the one or more payment divisions is received to cause payment to be made for the one or more payment divisions. In one embodiment, the method also includes creating a notification which indicates that the at least one payment division is purchased.

### CROSS REFERENCE TO RELATED APPLICATION

The present application claims priority under 35 U.S.C. 119 of U.S. provisional patent application No. 60/239,418, filed Oct. 10, 2000, which is incorporated herein by reference in its entirety.

### BACKGROUND OF THE INVENTION

1. Field of Invention

The present invention relates generally to the network-based commerce. More particularly, the present invention relates to enabling gift purchasers to contribute towards the purchase of a gift in a networked environment.

2. Description of the Related Art

Gift registries, e.g., wedding gift registries and baby gift registries, have long been used to enable individuals to purchase items desired by gift registrants. The use of gift registries serves to ensure that gift recipients receive at least some items which they desire. As the use of computer networks, particularly the Internet and the World Wide Web, grows, the use of gift-registries “on-line,” i.e., on a network, has also been growing. The growth has been due, at least in part, to the fact that many consumers enjoy the convenience of being able to shop from their personal computers.

While the use of registries is generally useful, in some cases, the usefulness of registries is tempered by the fact that some potential registrants may not require items which may be included in a registry. For example, many couples who are planning a wedding may already possess a majority of the household goods which are typically included in registries. Such couples may not wish to register for, or even receive, items which are not truly needed.

At the same time, couples who are not lacking for material goods, e.g., household goods, may be in need of financial assistance with the exorbitant costs of all aspects of a wedding. The aspects generally include, but are not limited to, the wedding itself, the reception which typically follows the wedding, and the often requisite honeymoon vacation. However, requesting financial assistance in lieu of a wedding gift is generally not considered to be acceptable.

Many gift givers are rewarded by the satisfaction that their gifts are appreciated or greatly needed. Such gift givers may wish to contribute funds towards the purchase of an item or commodity that a recipient would otherwise have to pay for himself or herself. In general, in order for a gift giver to contribute towards the purchase of a relatively expensive item or commodity, the gift giver would typically either have to give a recipient cash, or the gift giver would have to contact other individuals to pool resources to purchase a relatively expensive item or commodity. Many gift givers are uncomfortable with the idea of giving cash as a gift, and locating individuals to pool resources may be a time-intensive proposition. Hence, many gift givers often settle for purchasing a gift which is not necessarily needed by the recipient of the gift.

Therefore, what is desired is a method and an apparatus for enabling gift purchasers to readily contribute increments towards the purchase of a relatively costly gift such as a vacation. More specifically, what is needed is a system which enables a registrant to register for a relatively expensive gift that may be paid for by different individuals in increments.

### SUMMARY OF THE INVENTION

The present invention relates to the purchase of increments of either a physical commodity or a non-physical commodity. According to one aspect of the present invention, a computer-implemented method for processing a request to purchase a portion of a commodity that is divided into multiple payment divisions includes receiving a request to purchase at least one of the payment divisions. After receiving a request to purchase the one or more payment divisions, payment information associated with the purchase of the one or more payment divisions is received to cause payment to be made for the one or more payment divisions. In one embodiment, the method also includes creating a notification which indicates that the at least one payment division has been purchased.

In another embodiment, the commodity is a vacation, and each payment division selected from the multiple payment divisions is associated with aspects of the vacation. By way of example, the aspects of the vacation may include lodging, meals, recreation, and transportation. In such an embodiment, receiving a request to purchase one or more payment divisions may include receiving a request to purchase a night of lodging, a meal, an excursion, or the use of a rental car. Hence, a purchaser may contribute to a relatively high-priced item and effectively take part in the purchase of the item.

According to another aspect of the present invention, a server that is part of a client-server computing environment may process a request to purchase a portion of a commodity that is divided into multiple payment divisions. Such a server generally includes a receiving mechanism and a processing mechanism. The receiving mechanism is arranged to receive a request to purchase at least one payment division, and to receive payment information associated with the purchase of the payment division. The processing mechanism is arranged to process the payment information to cause payment to be made for the at least one payment division. In one embodiment, the receiving mechanism communicates with a client across a communications link, e.g., a network connection or an internet connection.

According to still another aspect of the present invention, a method for processing a purchase of a first component of a travel holiday which is partitioned into multiple components includes displaying at least a first representation of the first component of the travel holiday. The display of the first representation is such that the first component is effectively identified as being available for purchase. The method also includes receiving a selection of the first representation of the first component, displaying at least one payment option that is suitable for affecting the purchase of the first component, and receiving a payment selection in response to the display of the payment option. The payment selection is associated with the least one payment option, and receiving the payment selection includes receiving payment information. Once the payment information is received, the payment information is processed, and the first component is identified as being unavailable for future purchase. Identifying the first component as being unavailable for future purchase includes augmenting the first representation to indicate that the first component is unavailable for future purchase.

These and other advantages of the present invention will become apparent upon reading the following detailed descriptions and studying the various figures of the drawings.

### BRIEF DESCRIPTION OF THE DRAWINGS

The invention may best be understood by reference to the following description taken in conjunction with the accompanying drawings in which:

FIG. 1a is a diagrammatic representation of a first networked computing system that is suitable for implementing the present invention.

FIG. 1b is a diagrammatic representation of a second networked computing system that is suitable for implementing the present invention.

FIG. 2 is a process flow diagram which illustrates the steps associated with registering for a desired commodity for which increments may be paid for by purchasers in accordance with an embodiment of the present invention.

FIG. 3 is a process flow diagram which illustrates the steps associated with purchasing at least a portion of a commodity in accordance with an embodiment of the present invention.

FIG. 4 is a process flow diagram which illustrates the steps associated with processing a purchase of a portion of a commodity in accordance with an embodiment of the present invention.

FIG. 5 is a process flow diagram which illustrates the steps associated with processing a purchase of a component of a commodity in accordance with another embodiment of the present invention.

FIG. 6 is a process flow diagram which illustrates the steps associated with allowing purchase of portions of a commodity after an offering period has ended in accordance with an embodiment of the present invention.

FIG. 7a is a process flow diagram which illustrates the steps associated with one method of acknowledging that purchases have been made in accordance with an embodiment of the present invention.

FIG. 7b is a process flow diagram which illustrates the steps associated with a second method of acknowledging that purchases have been made in accordance with an embodiment of the present invention.

### DETAILED DESCRIPTION OF THE EMBODIMENTS

Conventionally, in order for a gift giver to contribute towards the purchase of a relatively expensive item or commodity to be given as a gift, the gift giver often must provide the recipient of the item or commodity with cash to defray the cost of the item or commodity. Alternatively, the gift giver may choose to contact other individuals to initiate a pooling of resources to purchase the item or commodity. Many gift givers are uncomfortable with the idea of giving cash as a gift. Further, locating individuals who are willing to pool resources to purchase an item or commodity may be a time-intensive proposition.

In one embodiment of the present invention, gift givers may readily contribute towards the purchase of a relatively pricey gift or a commodity through a registry which may be accessible, for example, on the Internet or the World Wide Web. Such a registry may be arranged to display payment increments, which a gift giver may purchase, that are associated with the pricey gift or commodity desired by the registrant. By way of example, many couples who are to be wed may wish to have their wedding guests contribute funds towards a honeymoon vacation. Such couples may fill out a registry which effectively lists the details of the honeymoon vacation, e.g., transportation information and lodging information. Wedding guests may then access the registry, and elect to contribute funds towards the honeymoon vacation. As a result, the wedding guests are essentially providing couples which typically much-needed help towards the payment of the honeymoon vacation.

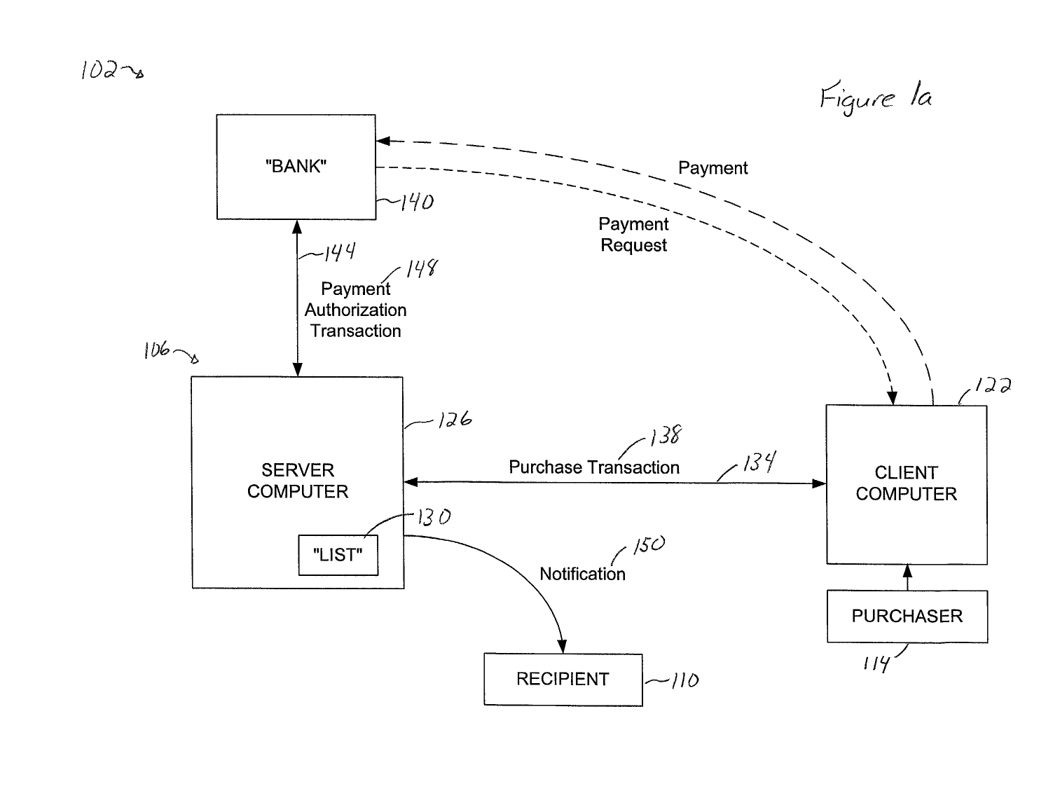

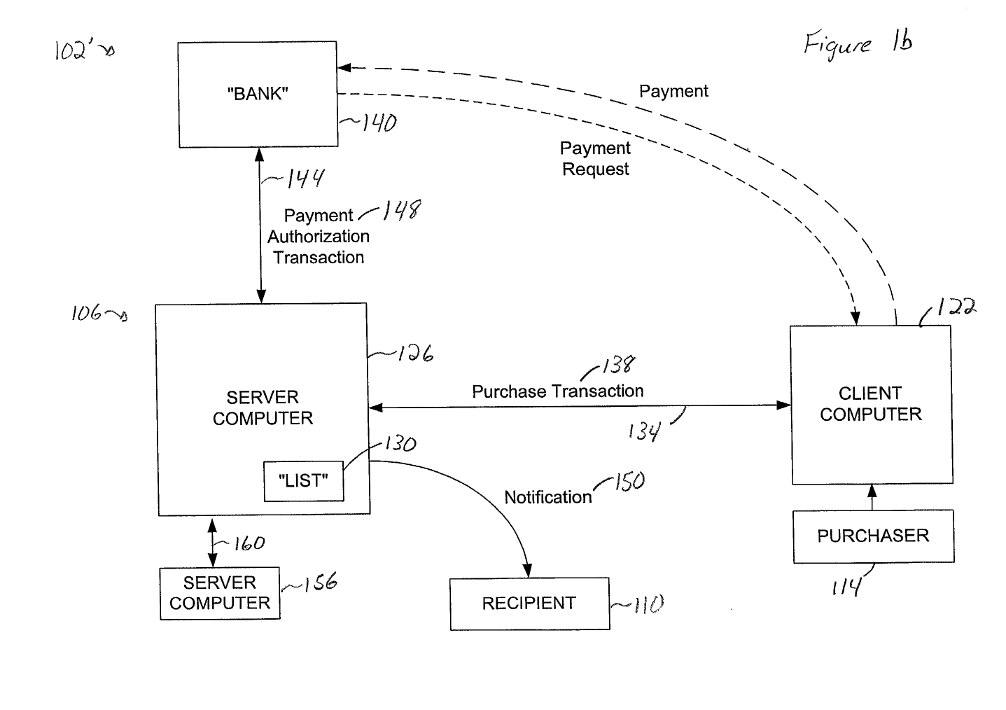

A system which enables “recipients” to select a desired commodity such as a vacation, and also enables “purchasers” to pay for portions of the commodity, may be implemented on a computing network. FIG. 1a is a diagrammatic representation of a first networked computing system that is suitable for implementing the present invention. A system 102 generally includes at least one client computer 122 and at least one server computer 126 that are a part of a client-server computing system 106. As will be appreciated by those skilled in the art, client computer 122 and server computer 126 may each include at least one processor, memory storage capability, databases, read-only memory (ROM), random access memory (RAM), a display device, and a data entry device. Client computer 122 and server computer 126 are generally each also arranged to read substantially any suitable computer readable media including, but not limited to, data signals embodied in carrier waves, floppy disks, optical disks, tape drives, compact disc read-only memories (CD-ROMs), digital versatile disks (DVDs), and various other data storage devices.

Server computer 126 and client computer 122, which is generally a remote computing device with respect to server computer 126, may be linked through a communications link 134 over which a transaction 138 may occur. Data may pass across communications link 134 in the form of a data signal embodied in a carrier wave. In one embodiment, communications link 134 may be a network link which enables server computer 126 and client computer 122 to communicate, for example, over the Internet or the World Wide Web. Although not shown, various security devices such as firewalls may be included between server computer 126 and client computer 122 to provide security within computing system 106.

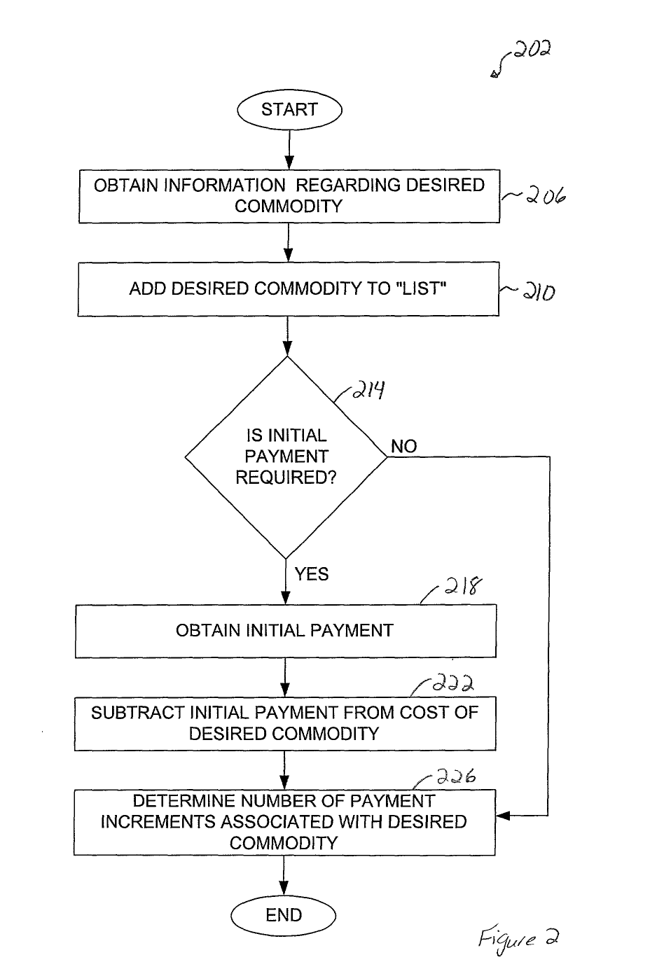

When a potential recipient 110 registers or otherwise selects a commodity or commodities he or she would like to receive, recipient 110 may create a list 130, as will be discussed below with respect to FIG. 2. In one embodiment, list 130 is effectively a gift registry that is stored with respect to server computer 126. Recipient 110 may create list 130 by substantially directly interacting with server computer 126, or by interacting with a client computer that is at least temporarily linked to server computer 126, e.g., from a personal computer at the home of the client that is linked via a telephone line to server computer 126. That is, recipient 110 may essentially automatically create list 130 using substantially only server computer 126.

When a purchaser 114 wishes to purchase at least a portion of a commodity included in list 130, purchaser 114 may interact with server computer 126 through client computer 122 to access list 130. Client computer 122 may be a personal computer that is accessible to purchaser 114. Alternatively, client computer 122 may be associated with a terminal, e.g., a terminal at a travel agency or a retail store, that may be accessible to purchaser 114.

During transaction 138, client computer 122 exchanges information with server computer 126 to cause the purchase of at least a portion of the commodity. Typically, during the course of transaction 138, purchaser 114 may attempt to pay for the portion of the commodity using a credit card or other payment mechanism that is issued by a financial institution such as a bank 140. In the described embodiment, server computer 126 communicates with bank 140 across a communications link 144 as a part of a payment authorization transaction 148. It should be appreciated that communications link 144 may be a telephone line or a network link. During payment authorization transaction 148, server computer 126 may request authorization, and bank 140 may grant authorization. Once authorization is granted, transaction 138 across communications link 134 may be completed. When transaction 138 is completed, recipient 110 may receive a notification 150 from server 126 that purchaser 114 has completed transaction 138. For example, notification 150 may be in the form of a gift card that is sent to recipient 110, or notification 150 may be an e-mail message that is transmitted to recipient 110.

As will be understood by those skilled in the art, bank 140 authorizes payment on behalf of purchaser 114. Bank 140 will eventually request payment from purchaser 114 to effectively pay for the purchase of at least a portion of a commodity associated with list 130. Such payment is often arranged to enable purchaser 114 to directly pay bank 140. By way of example, purchaser 114 may use a credit card issued by bank 140 to complete transaction 138, then pay bank 140 directly when bank 140 issues a credit card bill.

In one embodiment, server computer 126 may be in communication with other server computers. The other server computers may be associated with, for example, airlines, travel agencies, and organizations which issue gift certificates. FIG. 1b is a diagrammatic representation of a second networked computing system in which server computer 126 communicates with other server computers. Within a system 102′, server computer 126 is in communication with at least another server computer 156 across a communications link 160. When recipient 110 creates list 130, recipient may access server computer 156 through server computer 126. By way of example, if recipient 110 adds airfare to a select destination to list 130, server computer 156 may be an airline website which allows airline flights to be selected. Alternatively, if recipient 110 wishes to add a gift certificate to an establishment he or she wishes to patronize, e.g., during a honeymoon, server computer 156 may be associated either with the establishment or with an organization which effectively sells gift certificates associated with multiple establishments. It should be appreciated that server computer 156 facilitates enabling recipient 110 to create list 130 substantially automatically, e.g., without involving individuals such as travel agents or gift consultants.

Within system 102′, server computer 126 may serve as a link between client computer 122 and server computer 156. For example, when server computer 156 is an airline website, server computer 126 may serve as a link which enables purchaser 114 to purchase at least a portion of an airfare displayed on server computer 156. That is, server computer 126 may function as an interface which allows purchaser 114 to access information on server computer 156. In such a case, server computer 156 may track payments relating to the airfare, while server computer 126 provides access to server computer 126 and maintains list 130 which includes an indication of the number of payments which remain relating to the airfare.

With reference to FIG. 2, the steps associated with registering for a desired commodity, e.g., a honeymoon vacation, will be described in accordance with an embodiment of the present invention. A process 202 of registering begins at step 206 in which information regarding the desired commodity is obtained. In one embodiment, process 202 is a substantially automatic process which may be performed by a potential recipient substantially only through interfacing with a computer system. It should be appreciated, however, that process 202 may also be a substantially manual process which may involve interactions between a potential recipient, and another individual, e.g., a travel agent who has access to the computer system.

The information regarding the desired commodity may be obtained in step 206 by a computing system such as server computer 126 of FIG. 1a. In general, the obtained information may be widely varied. By way of example, when the commodity is a vacation, the information may include transportation information, lodging information, and activity information.

After the information regarding the commodity is obtained, the commodity is added to a list, i.e., list 130 of FIG. la, in step 210. As previously mentioned, list 130 may be part of a registry such as a bridal registry or a wedding registry. Adding the commodity to a list may include selecting the commodity by accessing a server computer which then enables the commodity to be substantially automatically added to the list, or manually adding the commodity to the list. A determination is then made in step 214 regarding whether initial payment for the commodity is required. If it is determined that an initial payment is required, the indication is that a down payment for the commodity is required, although it should be appreciated that in some embodiments, full payment for the commodity may required. Accordingly, process flow moves from step 214 to step 218 in which the initial payment is obtained. Typically, an initial payment may be made through the use of a credit card, e.g., by submitting a credit card account number which is received by a server computer.

Once the initial payment is obtained, the initial payment is effectively subtracted from the cost of the commodity in step 222. Then, in step 226, a number of payment increments associated with the commodity is determined. The number of payment increments may be determined automatically, e.g., using substantially standard criteria, or the payment increments may be determined based upon what a registrant or potential recipient considers to be acceptable. After the payment increments are determined, the process of registering for a desired commodity is completed.

Payment increments may be determined based upon the difference between the amount of an initial payment, if any, and the cost of the desired commodity. The number of payment increments may generally be widely varied. In one embodiment, the number of payment increments is determined based upon a fixed number. That is, payment increments may be fixed such that each increment is the same, or is a fixed dollar amount. Alternatively, the payment increments may vary depending upon the costs associated with portions of the commodity, i.e., the payment increments are not necessarily associated with the same amount. By way of example, if the commodity is a vacation, payment increments may be associated with the different components of the vacation. For instance, one payment increment may be associated with a night at a particular hotel, and another payment increment may be associated with a dinner at a particular restaurant.

Returning to step 214, if it is determined that initial payment is not required, then process flow proceeds directly to step 226 in which the number of payment increments associated with the commodity is determined. Once the number of payment increment is determined, the process of registering for the desired commodity is completed.

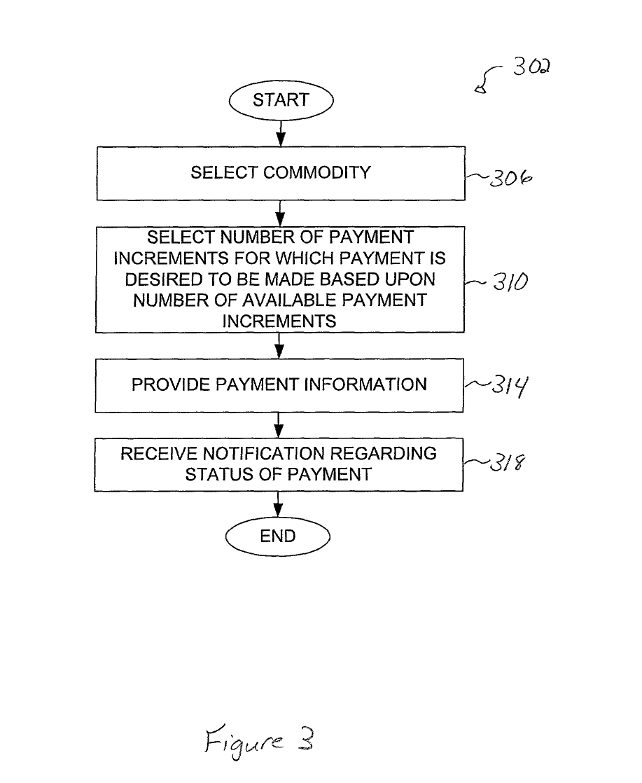

After a list is created by a recipient, the list may then be made available on a server computer which is accessible to a client computer. By way of example, the list may be made available at a website which is accessible to client computers such as personal computers. When an individual wishes to make a purchase from the list, the individual may access the list through a client computer. Referring next to FIG. 3, a method of making a purchase of at least a portion of a commodity from a list will be described in accordance with an embodiment of the present invention. A process 302 of making a purchase from a list begins at step 306 in which the individual, e.g., purchaser, selects an available commodity from the list of his or her chosen recipient.

If the purchaser decides to purchase at least a portion of the commodity, the purchaser selects a number of payment increments for which payment is desired to be made in step 310 based upon the number of available payment increments. The number of available payment increments, it should be appreciated, is dependent upon the number of previously purchased payment increments. Once the purchaser selects the number of payment increments to be purchased, the purchaser provides payment information 314. In general, the payment information may be provided as a credit card account number or an electronic cash account number such that processing of payment may be performed substantially immediately. Alternatively, the purchaser may prefer to send payment in the form of a personal check.

After payment information is provided, the purchaser receives notification regarding the status of his or her payment in step 318. Payment notification may be in the form of a notification screen displayed to the purchaser, an electronic mail message sent to an account owned by the purchaser, or a mailing, e.g., a mailing through the U.S. postal service. After payment notification is received by the purchaser, the process of purchasing at least a portion of a commodity is completed.

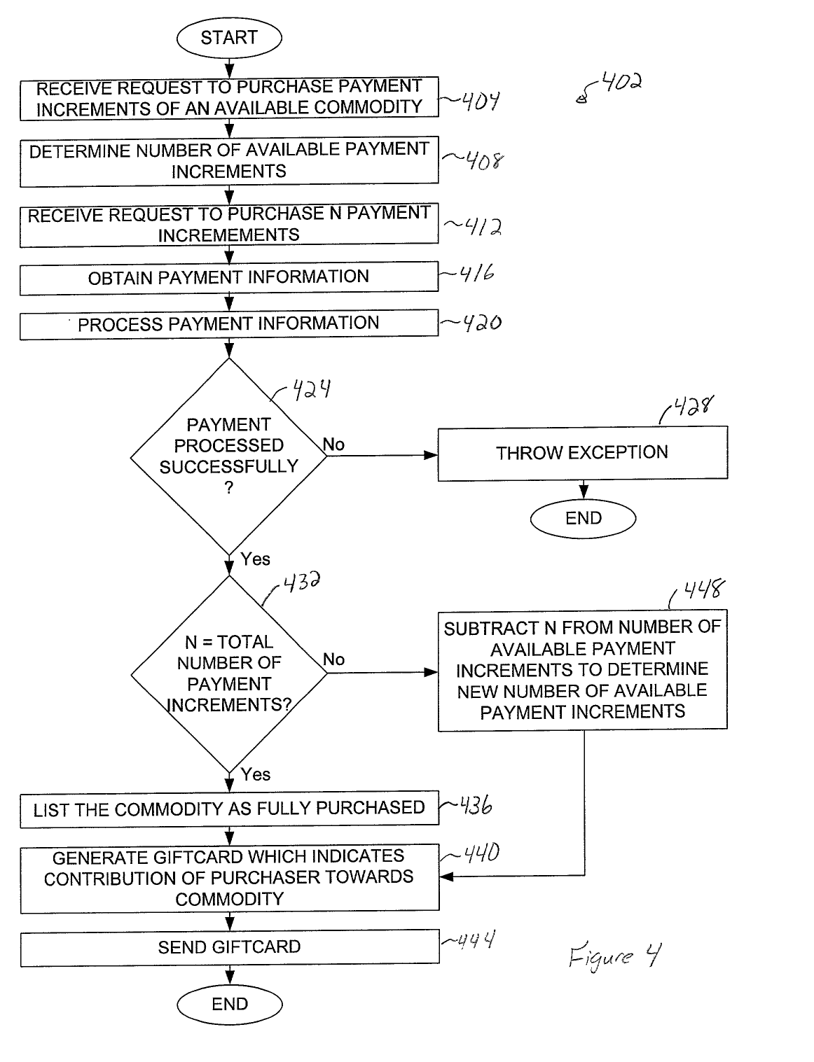

When a purchaser attempts to purchase at least a portion of a commodity, the purchaser generally accesses a server on which the purchase of the commodity is managed. Specifically, the purchaser may access a client computer which is in communication with a server computer on which the purchase of the commodity is managed. The processing which a server computer performs in response to purchasing information provided through a client computer will be described with respect to FIG. 4 in accordance with an embodiment of the present invention. A method 402 of processing a purchase request from a client begins at step 404 in which a request to purchase payment increments of an available commodity is received, e.g., from a purchaser through a client computer.

Upon receiving a request to purchase payment increments, the number of available payment increments is determined in step 408. By way of example, if a commodity is a vacation which is partitioned into a fixed number of fixed cost payment increments, then it is determined how many payment increments remain, or have yet to be purchased. After the number of payment increments is determined, a request is received in step 412 which specifies the number N of payment increments which are to be purchased.

In step 416, payment information is obtained and, in step 420, the payment information is processed. Typically, payment information will include a credit card account number or an electronic cash account number. As such, processing the payment information may involve obtaining a credit transaction authorization or debiting an electronic cash account, respectively. A determination is made in step 424 as to whether payment for the N payment increments was processed successfully. That is, it is determined if payment transaction approval was successfully obtained. If payment transaction approval is not approved and, hence, the payment for N payment increments was not successfully processed, then an exception may be thrown in step 428. That is, an indication that the transaction has not been approved may be generated. Once the exception is thrown, the processing of a purchase request is terminated.

Alternatively, if it is determined in step 424 that payment for the N payment increments has been successfully processed, then process flow moves to step 432 in which a determination is made regarding whether the number N of payment increments purchased by the purchaser is equal to the total number of available payment increments. If the number N of payment increments purchased is equivalent to the total number of available payment increments, then in step 436, the commodity is listed as fully purchased, or unavailable. As such, when other purchasers view the list of commodities desired by a recipient, the commodities that are fully purchased may be displayed as being unavailable for purchase.

After the commodity is listed as fully purchased, a gift card is generated which indicates the contribution of the purchaser towards the commodity in step 440. In general, such a gift card may be electronically generated, and sent in an electronic mail message, or the gift card may be a physical gift card which may be provided to the recipient of the commodity. Once the gift card is sent in step 444, the processing of a purchase request is completed.

Returning to step 432, if it is determined that the number N of payment increments purchased is not equivalent to the total number of available payment increments, then the implication is that additional payment increments remain available for purchase. Accordingly, process flow moves from step 432 to step 448 in which the number N is subtracted from the number of available payment increments to determine a new total number of available payment increments. When the new total number of available payment increments is determined, a gift card is generated in step 440 which indicates the contribution of the purchaser towards the commodity.

In one embodiment of the present invention, a commodity may be a trip such as a honeymoon vacation planned by a couple that is to be married. In lieu of dividing the overall cost of the trip into payment increments, the various components of the trip may effectively be the payment increments, as mentioned above. For instance, the components may include nights at a particular hotel, particular meals at selected restaurants, days for which a rental car is desired, and various recreational activities associated with the trip. Components may also include a general cash, or “slush,” fund which may serve to provide the couple with spending money for use during the trip. A purchaser may then choose a particular component of the trip that he or she wishes to purchase or, in the case of the slush fund, a particular component that he or she wishes to contribute to.

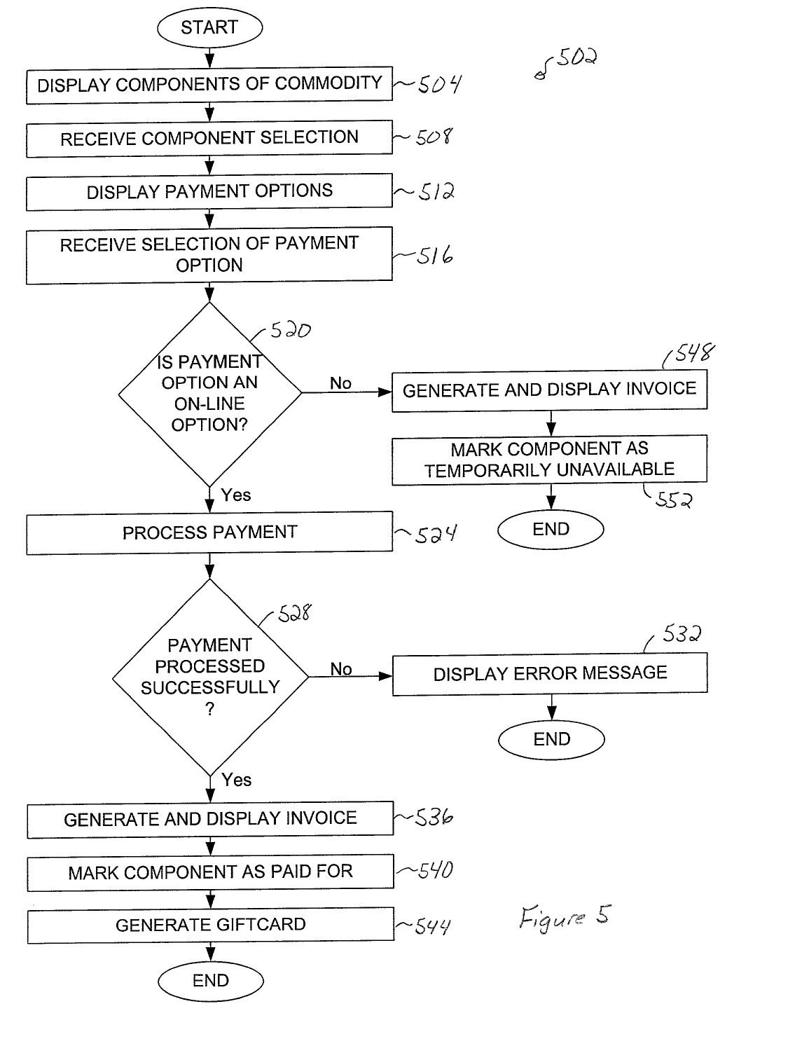

FIG. 5 is a process flow diagram which illustrates a method of processing a purchase for a component of a commodity such as a vacation or a trip in accordance with another embodiment of the present invention. A method 502 of processing a purchase for a component begins in step 504 in which the components of the commodity are displayed, as for example as a part of a website associated with the World Wide Web. It should be understood that displaying the components generally involves displaying representations of the components. The representations of the components may include, but are not limited to substantially any combination of, icons, pictures, and text. Once the components, which may include both components which are available for purchase and components which have previously been purchased, are displayed, the components may generally be viewed by a purchaser, e.g., from a client computer that is connected to the World Wide Web.

In step 508, a component selection is received. That is, when a purchaser selects a component which he or she wishes to purchase, information pertaining to the selected component is received. In response to the receipt of the component selection, various payment options may be displayed in step 512. After a desired payment option is selected by the purchaser, information associated with the selection is received in step 516.

In the described embodiment, payment options may include on-line payment options and off-line payment options, or payment options which involve payment using checks or the like. As such, a determination is made in step 520 as to whether the selected payment option is an online option. If it is determined that the payment option is an online option, then the indication is that payment may effectively be completed on-line. Accordingly, in step 524, payment from a purchaser is processed. Specifically, payment information is obtained from the purchaser, and an attempt is made to get authorization for a payment transaction, e.g., with a credit card account issuer. After payment is processed, a determination is made in step 528 regarding whether the payment was processed successfully.

If it is determined that the payment was not processed successfully, then the indication is that payment information obtained from the purchaser was either inaccurate or invalid. Hence, process flow moves from step 528 to step 532 in which an error message is displayed to indicate that that the payment processing was unsuccessful. Once the error message is displayed, the processing of a purchase is terminated.

Alternatively, if it is determined in step 528 that the payment was processed successfully, then the implication is that payment authorization has been received. In response to the successful processing of the payment, an invoice is generated and displayed in step 536. The invoice may include a listing of the component that was purchased, the purchase price associated with the component, and payment information. It should be appreciated that a hard copy of the invoice may also be created, in some embodiments, and provided to the purchaser. Once the invoice is generated, the component that was purchased is effectively marked as paid for in step 540. Marking the component as paid for may include, but is not limited to, augmenting a representation of the component such that the next time the representation of the component is displayed, the representation includes an indication that the component is no longer available for purchase.

After the component is marked as paid for in step 540, a gift card, which may either be associated with a physical card or an e-mail message, is generated in step 544. The gift card may be sent to the recipient of the component through electronic mail or a postal service, as appropriate. The gift card may also be provided to the purchaser to enable the purchaser to present the gift card to the recipient. In one embodiment, when gift card is sent to a recipient, a gift certificate or voucher associated with the purchased component may also be sent. For example, if the component that is paid for is a dinner at a particular establishment, a gift certificate or a voucher for the amount of the purchase that may be used at the particular establishment may be sent along with the gift card. Once the gift card is generated, the processing of a purchase is completed.

When a component is paid for, the cash value of the component may be provided to a recipient as a gift. That is, when a purchaser purchases a component for the recipient, the recipient may receive the cash value of the component along with a gift card which indicates that the purchaser has purchased the component. If the recipient receives the cash value of the component, there is essentially no guarantee that the recipient will apply the cash value towards the component, which may disappoint the purchaser who has spent time selecting the particular component. As such, issuing a gift certificate or a voucher may ensure that the recipient actually receives the specific component purchased by the purchaser. By way of example, when a purchaser has purchased a night at a particular hotel as a gift to the recipient, if the recipient receives a gift certificate issued by the hotel in lieu of the cash value of the night at the particular hotel, then the purchaser may be assured that his or her intended gift has effectively been received. Alternatively, if the recipient receives cash in the amount of the cost of a night at the particular hotel, then the recipient is free to use the cash for substantially any purpose, which may not be acceptable to the purchaser in some cases.

Returning to step 520 and the determination of whether the selection of the payment option that is received is an on-line option, if it is determined that the selected option is not an on-line option, then the indication is that the purchase of the selected component may not be completed until payment is received. As such, process flow moves to step 548 in which an invoice is generated and displayed. The invoice may indicate an amount owed for the purchase of the selected component, and request payment for the selected component by a certain date. After the invoice is generated and displayed, the selected component is marked as temporarily unavailable in step 552. Marking the component as temporarily unavailable for purchase may include, but is not limited to, augmenting a representation of the component such that the next time the representation of the component is displayed, the representation includes an indication that the component temporarily unavailable for purchase, or has effectively been reserved for purchase. It should be appreciated that if payment is not ultimately completed for the selected component, the component will eventually be displayed as being available. Alternatively, when payment is completed for the selected component, the selected component will be marked as being paid for and, hence, unavailable for future purchase. Once the component is marked as temporarily unavailable, the processing of a purchase is completed.

In one embodiment, a gift card may be e-mailed or sent and a corresponding selected component that has been paid for may be credited to a recipient substantially only after an “offering period” has expired. That is, a gift card and a corresponding component may be withheld from the recipient until all components have been purchased, whether the components are purchased by purchasers or by the recipient. By way of example, if a purchaser purchases a night at a hotel, the recipient may not receive a certificate for the night at the hotel until the offering period has expired, i.e., the night at the hotel may not be officially paid for until the offering period has expired. By delaying the receipt of a component, a purchaser is given the opportunity to rescind his or her purchase.

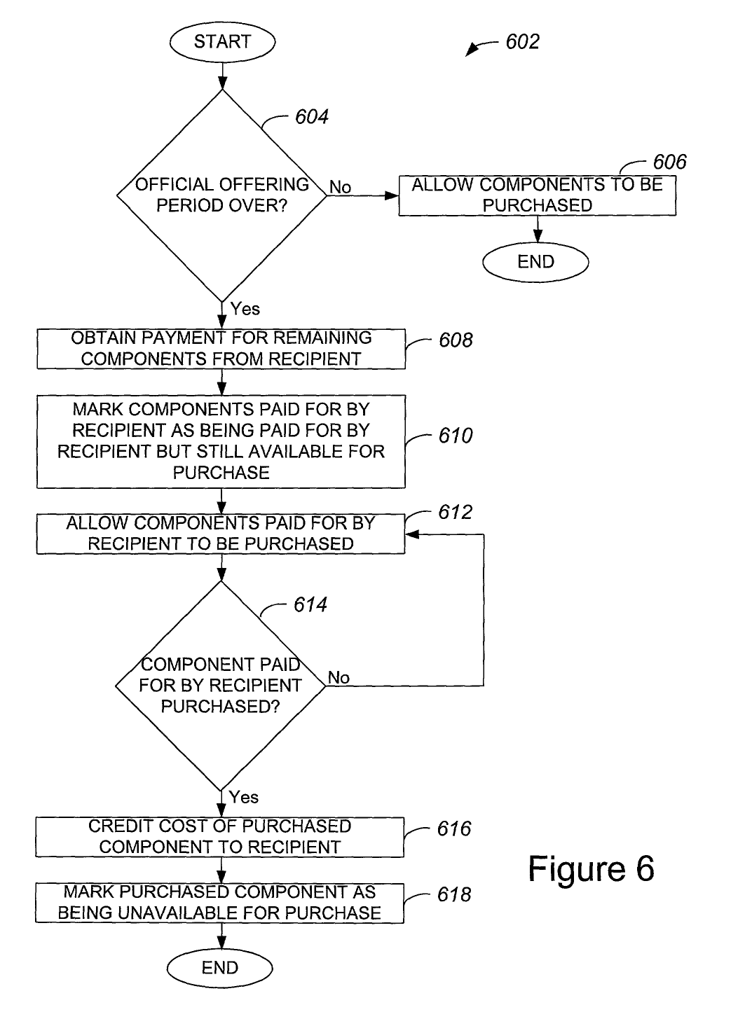

An offering period may be a period of time that begins when the recipient creates a list, e.g., a registry, and ends when it effectively becomes necessary to complete the purchase of substantially all components on the list. When the offering period is over or expires, the recipients may themselves substantially automatically purchase all unpurchased components, e.g., through the use of a credit card. However, components which have been purchased by the recipients after the offering period has ended may still be made available for purchase. With reference to FIG. 6, one method of allowing purchase of portions of a commodity after an offering period has ended will be described in accordance with an embodiment of the present invention. A process 602 of allowing components to be purchased begins at step 604 in which a determination is made regarding whether an official offering period is over. If it is determined that the official offering period is not over, then process flow moves to step 606 in which payment increments or components are allowed to be purchased, e.g., as described above with respect to either FIG. 4 or FIG. 5.

Alternatively, if it is determined in step 604 that the official offering period is over, then the indication is that the recipient who has requested the commodity is to complete the purchase of the commodity. Accordingly, process flow moves from step 604 to step 608 in which payment for the remaining components or payment increments is obtained from the recipient. In one embodiment, a site or organization which oversees the purchase of the commodity, e.g., the site or organization which maintains the registry list of the recipient or registrant, substantially automatically charges the remaining components or payment increments to a credit card associated with the recipient.

Once payment is obtained from the recipient, the components or payment increments may be marked as being paid for by the recipient in step 610. The components or payment increments may further be marked as still being available for purchase. Marking the components or payment increments may include displaying a list which indicates that certain components or payment increments, while paid for by the recipient, are available for purchase. In step 612, the components or payment increments paid for by the recipient are made available for purchase. The recipient may purchase the components or payment increments as described above with respect to FIG. 5 and FIG. 4, respectively.

A determination is made in step 614 regarding whether a component or payment increment that has been paid for by the recipient has been purchased by a purchaser. That is, it is determined if any purchase has been made after the offering period has ended. If it is determined that no such purchase has been made, then process flow returns to step 612 in which the components or payment increments are still available for purchase. Alternatively, if it is determined that such a purchase has been made, then the cost of the purchased component or payment increment is credited to the recipient in step 616. In other words, the money spent by the recipient to pay for the purchased component or payment increment is effectively returned to the recipient, e.g., by crediting the credit card of the recipient or by sending a check to the recipient.

After the cost of the purchased component or payment increment is credited back or otherwise returned to the recipient, the purchased component or payment increment is then marked as being unavailable for purchase in step 618. Once the component or payment increment is marked as being unavailable for purchase, the process of allowing purchase of portions of a commodity after an offering period has ended is completed.

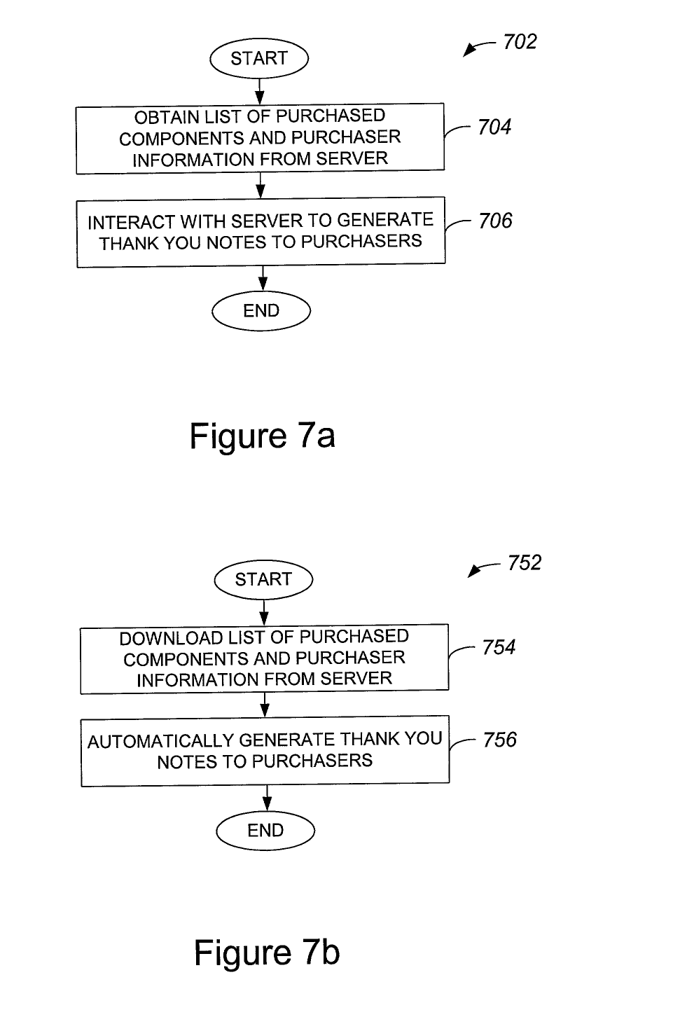

When an offering period has ended, or at some point after the offering period has ended, a recipient may obtain a listing of all purchases which have been made towards a commodity desired by the recipient. Such a listing may include contact information for the purchasers that may be used by the recipient when the recipient acknowledges receipt of the purchasers' contributions. FIG. 7a is a process flow diagram which illustrates a method of acknowledging that purchases have been made in accordance with an embodiment of the present invention. A process 702 begins at step 704 in which a list of purchased components or payment increments and purchaser information is obtained from a server, e.g., server computer 106 of FIG. 1a. Typically, such a list is maintained substantially separately form the list created by the recipient, e.g., the list discussed created by the recipient as discussed above with respect to FIG. 2. The recipient may obtain the list of purchased components or payment increments by accessing the server substantially directly. In step 706, the recipient may interact with the server to generate acknowledgements or “thank you” notes to the purchasers. The server may either send acknowledgements through e-mail, or the server may cause printed acknowledgements to be generated and sent, e.g., through the U.S. Postal Service. Once the acknowledgements are generated, the process of acknowledging purchases is completed.

FIG. 7b is a process flow diagram which illustrates the steps associated with another method of acknowledging that purchases have been made in accordance with an embodiment of the present invention. A process 752 begins at step 754 in which a list of purchased components or payment increments and purchaser information is downloaded by a recipient from a server, e.g., server 106 of FIG. 1a. The recipient may generally download such a list onto a personal computer that he or she has access to. Once the list is downloaded, the recipient may automatically generate thank you notes or acknowledgements using his or her personal computer in step 756. By way or example, the personal computer of the recipient may generate acknowledgements to the purchasers electronically. It should be appreciated that in one embodiment, the recipient may use the downloaded list to manually generate acknowledgements. Once thank you notes or acknowledgements are generated, the process of acknowledging purchases is completed.

Although only a few embodiments of the present invention have been described, it should be understood that the present invention may be embodied in many other specific forms without departing from the spirit or the scope of the present invention. By way of example, although the use of a contribution-based gift or trip registry has been described as being suitable for use to provide wedding-related gifts and trips, a contribution-based registry may generally be applied to a variety of other areas. Specifically, a contribution-based registry may be used to contribute to the purchase of substantially any item, particularly relatively expensive items. Such items may include material goods, such as automobiles and homes, as well as non-material or non-physical commodities. Non-material goods or commodities may include, but are not limited to, gift certificates, college funds, investment funds, savings bonds, and certificates of deposit.

Payment increments or divisions of a commodity such as a trip or a vacation have generally described as being determined based on either a fixed monetary amount of a fixed component amount. In other words, a trip for which portions may be paid for by different purchasers is often divided into either fixed payment increments or increments based upon divisions such as a night of lodging, a meal, or a recreational activity, i.e., a purchaser may pay for a fraction of a trip or for a particular component of the trip. It should be appreciated, however, that payment increments may be divided in substantially any suitable manner. For example, a trip may be divided in terms of days such that the purchase of a payment increment or division effectively entails purchasing all aspects of a particular day of the trip. Such a purchase may include paying for substantially all lodging, meals, recreation, and transportation for a selected day.

The present invention may be implemented for use within overall wedding registry clearinghouse websites which provide access to wedding registries associated with various couples. For example, server 126 of FIG. 1a may be accessible to websites which enable purchasers or wedding guests to view substantially all wedding registries and information associated with a particular couple. Such websites, e.g., http://www.weddingchannel.com, may serve as an interface between a purchaser and server 126. That is, a website which serves as a wedding registry clearinghouse website may also access a server such as server 126.

In one embodiment, a recipient may pay for all or some components of a commodity substantially when he or she registers for the commodity. If the recipient does not pay for all of the components, the recipient may elect to pay for the critical components. By way of example, for a commodity that is a trip, the recipient may pay up front for airfare, accommodations, and a rental car, while not paying for less critical components such as dinners at specific establishments. When the recipient has paid up front for components, purchasers may purchase the components paid for by the recipient. Allowing the recipient to pay up front for components may ensure that the commodity, or at least more important components of the commodity, are paid for such that the recipient may be assured of collecting the commodity, e.g., going on a trip.

Generally, the steps associated with the various methods and processes of the present invention may be widely varied without departing from the spirit or the scope of the present invention. Steps may be altered, modified, added, removed, and reordered. By way of example, for an embodiment of processing a purchase of a payment increment in which only on-line payment is acceptable, the steps associated with determining whether a selected payment option is an on-line option may be eliminated. Also, while the steps of registering for a desired commodity have been described as including a determination of a number of payment increments, it should be appreciated that payment increments may instead be essentially random. That is, the amount that is paid by purchaser may be determined by the purchaser at the time of purchase, and may be substantially any amount that the purchaser chooses. Therefore, the present examples are to be considered as illustrative and not restrictive, and the invention is not to be limited to the details given herein, but may be modified within the scope of the appended claims.

What is claimed is:

1. A computer-implemented method for processing a request to purchase a portion of a commodity, the commodity having an associated cost, the cost being divided into multiple payment divisions, the computer-implemented method comprising:
receiving a request to purchase at least one payment division selected from the multiple payment divisions;
receiving payment information associated with the purchase of the at least one payment division; and
automatically processing the payment information to cause payment to be made for the at least one payment division.

2. The computer-implemented method as recited in claim 1 further including:
identifying the at least one payment division as being purchased.

3. The computer-implemented method as recited in claim 1 further including generating a notification, the notification being arranged to indicate that the at least one payment division is purchased.

4. The computer-implemented method as recited in claim 1 further including:
determining when the payment information is successfully processed, wherein when the payment information is determined to be successfully processed, the at least one payment division is identified as being purchased.

5. The computer-implemented method as recited in claim 1 wherein the request to purchase the at least one payment division is received across a communications link from a remote computing device.

6. The computer-implemented method as recited in claim 1 wherein the commodity is a vacation, and each payment division selected from the multiple payment divisions is associated with at least one aspect of the vacation.

7. The computer-implemented method as recited in claim 6 wherein each payment division selected from the multiple payment divisions is a specific aspect of the vacation, and automatically processing the payment information to cause the payment to be made for the at least one payment division causes the payment to be made for the specific aspect of the vacation.

8. A server suitable for use in a client-server computing environment, the server being arranged to process a request to purchase a portion of a commodity, the commodity having a cost, the cost being divided into multiple payment divisions, the server comprising:
a receiving mechanism, the receiving mechanism being arranged to receive a request to purchase at least one payment division selected from the multiple payment divisions, the receiving mechanism further being arranged to receive payment information associated with the purchase of the at least one payment division; and
a processing mechanism, the processing mechanism being arranged to automatically process the payment information to cause payment to be made for the at least one payment division.

9. The server according to claim 8 wherein the receiving mechanism is still further arranged to communicate with a client across a communications link.

10. The server according to claim 8 wherein the processing mechanism is further arranged to divide the cost of the commodity into the multiple payment divisions.

11. The server according to claim 8 further including:
a determining mechanism, the determining mechanism being arranged to determine when the payment information is successfully processed; and
a generator, the generator being arranged to generate a notification, the notification being arranged to indicate that the at least one payment division is purchased when it is determined that the payment information is successfully processed.

12. The server according to claim 8 wherein the commodity is a vacation, and each payment division selected from the multiple payment divisions is associated with an aspect of the vacation.

13. The server according to claim 8 further including:
an interface, the interface being arranged to enable communication between the server and a remote computing system, wherein the remote computing system provides the server with information associated with the commodity using the interface.

14. A computer program product for processing a request to purchase a portion of a commodity, the commodity having a cost, the cost being divided into multiple payment divisions, the computer program product comprising:
computer code for receiving a request to purchase at least one payment division selected from the multiple payment divisions;
computer code for receiving payment information associated with the purchase of the at least one payment division;
computer code for automatically processing the payment information to cause payment to be made for the at least one payment division; and
a computer readable medium that stores the computer codes

15. The computer program product according to claim 14 further including:
computer code for identifying the at least one payment division as being purchased.

16. The computer program product according to claim 14 further including computer code for generating a notification, the notification being arranged to indicate that the at least one payment division is purchased.

17. The computer program product according to claim 14 further including:
computer code for determining when the payment information is successfully processed, wherein when the payment information is determined to be successfully processed, the at least one payment division is identified as being purchased.

18. A computer program product according to claim 14 wherein the commodity is a vacation, and each payment division selected from the multiple payment divisions is associated with aspects of the vacation.

19. A computer program product according to claim 14 wherein the computer-readable medium is one selected from the group consisting of a data signal embodied in a carrier wave, a hard disk, a floppy disk, a tape, an optical disk, a CD-ROM, a DVD, and a computer memory.

20. A computer-implemented method for processing a purchase of a first component of a travel holiday, the first component being selected from a plurality of components, the computer-implemented method comprising:
displaying at least a first representation of the first component of the travel holiday, the first component being available for purchase;
receiving a selection of the first representation of the first component;
displaying at least one payment option, the at least one payment option being suitable for affecting the purchase of the first component;
receiving a payment selection, the payment selection being associated with the at least one payment option, wherein receiving the payment selection includes receiving payment information associated with the payment selection;
automatically processing the payment information; and
identifying the first component as being unavailable for future purchase, wherein identifying the first component as being unavailable for future purchase includes augmenting the first representation to indicate that the first component is unavailable for future purchase.

21. The computer-implemented method as recited in claim 20 further including displaying the augmented first representation.

22. The computer-implemented method as recited in claim 20 further including displaying representations of the plurality of components.

23. The computer-implemented method as recited in claim 20 further including:
determining when the payment information is successfully processed; and
identifying the first component as being unavailable for future purchase only when it is determined that the payment information is successfully processed.

24. The computer-implemented method as recited in claim 23 further including:
generating an invoice which includes at least a portion of the payment information, wherein the invoice identifies the first component as being purchased; and displaying the invoice.

25. A computer program product for processing a purchase of a first component of a travel holiday, the first component being selected from a plurality of components, the computer program product comprising:
computer code for displaying at least a first representation of the first component of the travel holiday, the first component being available for purchase;
computer code for receiving a selection of the first representation of the first component;
computer code for displaying at least one payment option, the at least one payment option being suitable for affecting the purchase of the first component;
computer code for receiving a payment selection, the payment selection being associated with the at least one payment option, wherein receiving the payment selection includes receiving payment information associated with the payment selection;
computer code for automatically processing the payment information;
computer code for identifying the first component as being unavailable for future purchase, wherein identifying the first component as being unavailable for future purchase includes augmenting the first representation to indicate that the first component is unavailable for future purchase; and
a computer-readable medium that stores the computer codes.

26. A computer-implemented method for automatically maintaining a registry list, the computer-implemented method comprising:
providing information associated with at least a first commodity;
receiving a selection for the first commodity, the first commodity having an associated cost;
dividing the cost into multiple payment divisions; and
creating the registry list, the registry list including an identifier that identifies the first commodity, the registry list further including indicators that identify the multiple payment divisions.

27. The computer-implemented method of claim 26 further including:
displaying the registry list; and
enabling at least one payment division included in the multiple payment divisions to be selected.

28. A computing system comprising:
a client computer; and
a primary server computer, the primary server computer being in communication with the client computer, the primary server computer being arranged to automatically maintain a list that includes an indication of at least one commodity that has an associated cost, the primary server computer being further arranged to divide the associated cost into a plurality of payment increments and to substantially automatically generate the list.

29. The computing system of claim 28 further including:
a secondary server computer, the secondary server computer being in communication with the primary server computer, wherein the secondary server computer includes information relating to the commodity and enables the client computer to interact with the primary server computer to initiate a purchase of at least one of the plurality of payment increments, wherein the purchased payment increment is effectively credited with respect to the secondary server computer.

30. The computing system of claim 28 wherein the primary server computer is arranged to substantially automatically generate the list using information provided by the client computer.

31. A computing system comprising:
means for obtaining information relating to a commodity, the information including a cost of the commodity;
means for processing the obtained information relating to the commodity, wherein the means for processing the obtained information includes means for dividing the cost into a plurality of increments;
means for automatically creating a registry list using the obtained information, wherein the registry list include information associated with the plurality of increments;
means for enabling at least one of the increments included in the plurality of increments to be automatically purchased; and
means for automatically updating the registry list to indicate that the at least one increment has been purchased.

32. The computing system according to claim 31 wherein the means for enabling the at least one of the increments included in the plurality of increments to be automatically purchased includes:
means for allowing payment to be made for the at least one of the increments; and
means for completing the automatic purchase of the at least one increment substantially after a predetermined period of time has elapsed.

33. The computing system according to claim 32 wherein the means for completing the automatic purchase includes means for providing a representation of the least one increment to a recipient substantially after the predetermined period of time has elapsed.

34. The computing system according to claim 33 wherein the representation is one of a gift certificate and a voucher.
